(19) United States
(12) Patent Application Publication
(10) Pub. No.: US 2025/0352900 A1
(43) Pub. Date: Nov. 20, 2025

(54) Human-Computer Interaction in Virtual and Interactive Media Applications

(71) Applicant: Tencent Technology (Shenzhen) Company Limited, Shenzhen (CN)

(72) Inventor: Yu Guan, Shenzhen (CN)

(21) Appl. No.: 19/282,409

(22) Filed: Jul. 28, 2025

Related U.S. Application Data
(63) Continuation of application No. PCT/CN2024/095510, filed on May 27, 2024.

(30) Foreign Application Priority Data
Jul. 14, 2023 (CN) 2023108679486

(51) Int. Cl. A63F 13/52; G06F 9/451

(52) U.S. Cl. CPC A63F 13/52; G06F 9/451

(57) ABSTRACT

This application provides a method and apparatus for interaction in a virtual scene, an electronic device, a computer-readable storage medium, and a computer program product. The method includes: displaying, by a terminal in the virtual scene, a first virtual object, a second virtual object, a target scene area, and a scene prop located in the target scene area, the first virtual object having a first skill; and controlling, in response to a first trigger operation for the first skill, the scene prop to be separated from the target scene area, and controlling the separated scene prop to interact with the second virtual object in cooperation with the first virtual object.

### CROSS-REFERENCE TO RELATED APPLICATIONS

This application is a Continuation Application of PCT Application PCT/CN2024/095510, filed May 27, 2024, which claims priority to Chinese Patent Application No. 2023108679486, filed Jul. 14, 2023, each entitled “Method and Apparatus for Interaction in Virtual Scene, Device, Storage Medium, and Computer Program Product” each of which is incorporated by reference in its entirety.

### FIELD

Aspects described herein relate to the field of virtualization and human-computer interaction technologies, and in particular, to a method and apparatus for interaction in a virtual scene, an electronic device, a computer-readable storage medium, and a computer program product.

### BACKGROUND

A display technology based on graphics processing hardware expands a channel for perceiving an environment and obtaining information. Especially, a multimedia technology of a virtual scene can implement, based on an actual application need by a human-computer interaction engine technology, diversified interactions between virtual objects that are controlled by users or artificial intelligence, has various typical application scenes, and for example, can simulate an actual interaction process between the virtual objects in a game scene.

In a related technology, when a virtual object is controlled to release a virtual skill for interaction in a virtual scene, the interaction is usually implemented through a skill effect generated by the virtual skill. As a result, application manners of the virtual skill in the virtual scene are limited, thereby reducing efficiency of interaction control in the virtual scene, and causing a waste of hardware processing resources.

### SUMMARY

Aspects described herein provide a method and apparatus for interaction in a virtual scene, an electronic device, a computer-readable storage medium, and a computer program product, to improve efficiency of interaction control in a virtual scene and utilization of hardware processing resources.

Technical solutions of the aspects described herein are implemented as follows:

An aspect described herein provides a method for interaction in a virtual scene, including:
displaying, in the virtual scene, a first virtual object, a second virtual object, a target scene area, and a scene prop located in the target scene area, the first virtual object having a first skill; and
controlling, in response to a first trigger operation for the first skill, the scene prop to be separated from the target scene area, and controlling the separated scene prop to interact with the second virtual object in cooperation with the first virtual object.

An aspect described herein further provides an apparatus for interaction in a virtual scene, including:
a display module, configured to display, in the virtual scene, a first virtual object, a second virtual object, a target scene area, and a scene prop located in the target scene area, the first virtual object having a first skill; and
a control module, configured to control, in response to a first trigger operation for the first skill, the scene prop to be separated from the target scene area, and control the separated scene prop to interact with the second virtual object in cooperation with the first virtual object.

An aspect described herein further provides an electronic device, including:
a memory, configured to store computer-executable instructions; and
a processor, configured to implement the method for interaction in a virtual scene according to the aspect described herein when executing the computer-executable instructions stored in the memory.

An aspect described herein further provides a computer-readable storage medium, having computer-executable instructions or a computer program stored therein, the computer-executable instructions or the computer program, when executed by a processor, implementing the method for interaction in a virtual scene according to the aspect described herein.

An aspect described herein further provides a computer program product, including computer-executable instructions or a computer program, the computer-executable instructions or the computer program, when executed by a processor, implementing the method for interaction in a virtual scene according to the aspect described herein.

The aspects described herein have the following beneficial effects:

In application of the above-mentioned aspects described herein, the first virtual object, the second virtual object, the target scene area, and the scene prop located in the target scene area are displayed in the virtual scene, and when the first trigger operation for the first skill is received, the scene prop is controlled to be separated from the target scene area, so that the separated scene prop is controlled to interact with the second virtual object in cooperation with the first virtual object. Herein, the scene prop is provided in the target scene area of the virtual scene. If the first virtual object triggers the first skill during interaction, the scene prop of the target scene area can be further invoked to interact with the second virtual object in cooperation with the first virtual object. In this way, the target scene area of the virtual scene provides the scene prop for the first skill to invoke, and application manners of a virtual skill in the virtual scene can be enriched, thereby improving efficiency of interaction control of the virtual scene, and improving utilization of hardware processing resources.

### BRIEF DESCRIPTION OF THE DRAWINGS

FIG. 1A is a schematic diagram of an application mode of a method for interaction in a virtual scene according to an aspect described herein.

FIG. 1B is a schematic diagram of an application mode of a method for interaction in a virtual scene according to an aspect described herein.

FIG. 2 is a schematic structural diagram of an electronic device 500 implementing a method for interaction in a virtual scene according to an aspect described herein.

FIG. 3 is a schematic flowchart of a method for interaction in a virtual scene according to an aspect described herein.

FIG. 4 is a schematic diagram of display of virtual props according to an aspect described herein.

FIG. 5 is a schematic diagram of transmission of virtual props according to an aspect described herein.

FIG. 6 is a schematic diagram of display of skill props according to an aspect described herein.

FIG. 7 is a schematic diagram of a process of merging of skill props and scene props according to an aspect described herein.

FIG. 8 is a schematic diagram of transmission of virtual props according to an aspect described herein.

FIG. 9 is a schematic diagram of conversion of a virtual scene area according to an aspect described herein.

FIG. 10 is a schematic flowchart of a method for interaction in a virtual scene according to an aspect described herein.

### DESCRIPTION OF ASPECTS

To make the objectives, technical solutions, and advantages described herein clearer, the following describes aspects in further detail with reference to the accompanying drawings. The described aspects are not to be considered as a limitation.

In the following descriptions, related “some aspects” describe a subset of all possible aspects. However, the “some aspects” may be the same subset or different subsets of all the possible aspects, and may be combined with each other without conflict.

The terms, involved in the following description, “first/second/third” are merely intended to distinguish between similar objects rather than describing specific orders. The “first/second/third” is interchangeable in proper circumstances to enable the aspects described herein to be implemented in orders other than those illustrated or described herein.

Unless otherwise defined, meanings of all technical and scientific terms used in the aspects described herein are the same as those usually understood by a person skilled in the art. Terms used in the aspects described herein are merely intended to describe objectives of the aspects described herein, but are not intended to limit this application.

In the aspects described herein, the term “module” or “unit” refers to a computer program with a predetermined function or a part of the computer program and works, together with other related parts, to implement a predetermined target, and may be completely or partially implemented by software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

Before the aspects described herein are further described in detail, a description is made on nouns and terms in the aspects described herein, and the nouns and terms in the aspects described herein are applicable to the following explanations.
1) Client: It is an application configured to provide various services and run in a terminal, for example, a client (such as a game client) supporting a virtual scene.
2) In response to: It is configured for representing a condition or status on which a to-be-performed operation depends. When the condition or status is satisfied, one or more operations may be performed in real time or after a set delay. Without being specifically stated, there is no limitation to the order in which the plurality of operations are performed.
3) Virtual scene: It is a virtual scene displayed (or provided) when an application runs on the terminal. The virtual scene may be a simulated environment of a real world, or may be a semi-simulated and semi-fictional virtual environment, or may be a completely fictional virtual environment. The virtual scene may be any one of a two-dimensional virtual scene, a two-and-a-half-dimensional virtual scene, or a three-dimensional virtual scene.

For example, the virtual scene may include sky, land, ocean, or the like. The land may include environmental elements such as desert and city, and a user may control a virtual object to perform an activity in the virtual scene. The activity includes, but is not limited to, at least one of adjusting a body posture, crawling, walking, running, riding, jumping, driving, picking, shooting, attacking, and throwing. The virtual scene may be displayed from a first-person view (for example, a user's own view is used to play a virtual object in a game), or may be displayed from a third-person view (for example, a user chases a virtual object in a game to play the game), or may be a virtual scene displayed from an aerial view. The perspectives may be switched randomly.
4) Scene data: It represents feature data of a virtual scene, and for example, may be a position of a virtual object in the virtual scene, or may be a position of a virtual building in the virtual scene, or may be a ground area occupied by the virtual building. Certainly, based on a type of the virtual scene, the scene data may include different types of feature data. For example, in the virtual scene of the game, the scene data may include a waiting time of various functions configured in the game (depending on a quantity of times the same function can be used in a specific time), and may further represent attribute values of various status of game characters, for example, a health point (also referred to as a red point), a magic point (also referred to as a blue point), a status point, and a blood volume.
5) Virtual object: It is a figure of various people and objects that can be interacted with in a virtual scene, or a movable object in the virtual scene. The movable object may be a virtual person, a virtual animal, an animation character, or the like, such as a person, an animal, a plant, an oil drum, a wall, or a stone displayed in the virtual scene. The virtual object may be a virtual image configured for representing a user in the virtual scene. The virtual scene may include a plurality of virtual objects, and each virtual object has a shape and a volume in the virtual scene, and occupies part of space in the virtual scene.

For example, the virtual object may be a user role controlled through operations on the client, or may be artificial intelligence (AI) set in a virtual scene battle through training, or may be a non-player character (NPC) set in virtual scene interaction. A quantity of virtual objects participating in the interaction in the virtual scene may be preset or dynamically determined based on a quantity of clients participating in the interaction.
6) Skill prop: It is a virtual prop generated by releasing a first skill. The skill prop may include a) a shooting prop, such as a virtual bullet, a virtual arrow, or a virtual flying sword, b) a throwing prop, such as a virtual dart, a virtual grenade, or a virtual throwing knife, and c) a landing prop, such as virtual lightning, virtual snowfall, virtual hail, or virtual rainfall.
7) Scene prop: When a skill prop stays in a target scene area in a virtual scene, the skill prop may be referred to as a scene prop.

Aspects described herein provide a method and apparatus for interaction in a virtual scene, an electronic device, a computer-readable storage medium, and a computer program product, to improve efficiency of interaction control in a virtual scene and utilization of hardware processing resources. These are separately explained below.

During example application of the relevant data collection and processing described herein, the informed consent or individual consent of a personal information subject needs to be obtained in strict accordance with the requirements of relevant laws and regulations, and the subsequent data use and processing behavior is carried out within the scope of authorization of laws and regulations and the personal information subject.

To facilitate an easier understanding of a method for interaction in a virtual scene according to an aspect described herein, an illustrative implementation scene of the method for interaction in a virtual scene according to the aspect described herein is described below. The virtual scene in the method for interaction in a virtual scene according to the aspect described herein may be outputted completely based on a terminal device, or outputted collaboratively based on a terminal device and a server.

In some aspects, the virtual scene may be an environment for game characters to interact, for example, may be an environment for game characters to battle in the virtual scene. Actions of virtual objects may be controlled for both parties to interact in the virtual scene, so that a user can experience the virtual scene in the game.

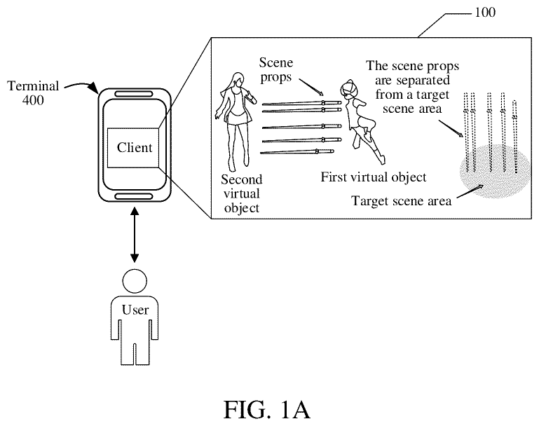

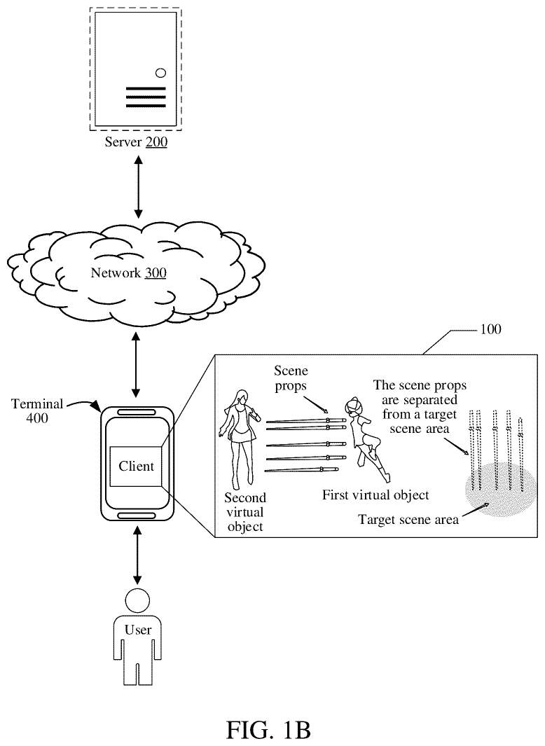

In an implementation scene, referring to FIG. 1A, FIG. 1A is a schematic diagram of an application mode of a method for interaction in a virtual scene according to an aspect described herein, and is applied to some application modes that completely depend on computing power of a terminal 400 to complete related data calculation of a virtual scene 100. For example, in a game in a standalone version or an offline mode, the virtual scene is outputted by the terminal 400 such as a smartphone, a tablet computer, or a virtual reality/augmented reality device. When forming visual perception of the virtual scene 100, the terminal 400 calculates, by graphics computing hardware, data needed for display, completes loading, parsing, and rendering of display data, and outputs, at graphics output hardware, a video frame that can form the visual perception of the virtual scene. For example, a two-dimensional video frame is presented on a display screen of a smartphone, or a video frame for implementing a three-dimensional display effect is projected on lenses of augmented reality/virtual reality glasses. In addition, to enrich a perception effect, the device may further use different hardware to form one or more of auditory perception, tactile perception, motion perception, and taste perception.

For example, the terminal 400 runs a client (such as a standalone game client), and outputs a virtual scene based on scene data of the virtual scene during running of the client. The virtual scene is an environment for game characters to interact, and for example, may be a plain, a street, a valley, or the like for the game characters to battle in. After the virtual scene is outputted, a first virtual object, a second virtual object, a target scene area, and a scene prop located in the target scene area may be further displayed in the virtual scene, the first virtual object having a first skill; and in response to a first trigger operation for the first skill, the scene prop is controlled to be separated from the target scene area, and the separated scene prop is controlled to interact with the second virtual object in cooperation with the first virtual object.

In another implementation scene, referring to FIG. 1B, FIG. 1B is a schematic diagram of an application mode of a method for interaction in a virtual scene according to an aspect described herein. The method is applied to a terminal 400 and a server 200, and is generally applied to an application mode in which virtual scene calculation is completed depending on computing power of the server 200, and the virtual scene is outputted at the terminal 400. That visual perception of a virtual scene 100 is formed is used as an example. The server 200 calculates related display data of the virtual scene, and transmits the display data to the terminal 400. The terminal 400 depends on graphics computing hardware to complete loading, parsing, and rendering of the calculated display data, and depends on graphics output hardware to output the virtual scene to form the visual perception. For example, a two-dimensional video frame may be presented on a display screen of a smartphone, or a video frame for implementing a three-dimensional display effect may be projected on lenses of augmented reality/virtual reality glasses. For the perception of the form of the virtual scene, corresponding hardware output of the terminal may be used. For example, microphone output is used to form auditory perception, and vibrator output is used to form tactile perception.

For example, the terminal 400 runs a client (for example, an online game client), obtains scene data of a virtual scene by connecting to a game server (namely the server 200), and outputs the virtual scene based on the obtained scene data, so as to perform game interaction with other users in the virtual scene. After outputting the virtual scene, the terminal 400 may further display, in the virtual scene, a first virtual object, a second virtual object, a target scene area, and a scene prop located in the target scene area, the first virtual object having a first skill; and control, in response to a first trigger operation for the first skill, the scene prop to be separated from the target scene area, and control the separated scene prop to interact with the second virtual object in cooperation with the first virtual object.

In some aspects, a server (for example, the server 200) may be an independent physical server, or may be a server cluster or distributed system including a plurality of physical servers. A terminal (for example, a terminal 400-1) may be a notebook computer, a tablet computer, a desktop computer, a smartphone, an intelligent voice interaction device (for example, a smart speaker), a smart home appliance (for example, a smart television), a smartwatch, an on-board terminal, a wearable device, a virtual reality (VR) device, or the like, but it is not limited thereto. The terminal and the server may be directly or indirectly connected through wired or wireless communication. This is not limited in the aspect described herein.

In some aspects, the method for interaction in a virtual scene according to the aspect described herein may be implemented by a cloud technology. The cloud technology is a hosting technology that unifies a series of resources such as hardware, software, and networks in a wide area network or a local area network to implement computing, storage, processing, and sharing of data. The cloud technology is a generic term of a network technology, an information technology, an integration technology, a management platform technology, an application technology, and the like based on application of a cloud computing business model, which may form a resource pool and are used on demand, thereby being flexible and convenient. The cloud computing technology becomes an important support. Backend services of a technological network system require a lot of computing resources and storage resources. In an example, the server (for example, the server 200) may alternatively be a cloud server that provides basic cloud computing services such as a cloud service, a cloud database, cloud computing, a cloud function, cloud storage, a network service, cloud communication, a middleware service, a domain name service, a security service, a content delivery network (CDN), big data, or an artificial intelligence platform.

In some aspects, a plurality of servers may form a blockchain, and the server is a node in the blockchain. There may be information connection between nodes in the blockchain, and information may be transmitted between the nodes through the information connection. Data (for example, the scene data of the virtual scene) related to the method for interaction in a virtual scene according to the aspect described herein may be saved in the blockchain.

In some aspects, the terminal or the server may implement the method for interaction in a virtual scene according to the aspect described herein by running various computer-executable instructions or a computer program. For example, the computer-executable instructions may be a microprogram-level command, machine instructions, or software instructions. The computer program may be an original program or a software module in an operating system, or may be a native application (APP), namely a program that needs to be installed in the operating system before being run, such as a game APP, or may be a mini program that can be embedded into any APP, namely a program that only needs to be downloaded into a browser environment to run. In a word, the above-mentioned computer-executable instructions may be any form of instructions, and the above-mentioned computer program may be any form of application, module, or plug-in.

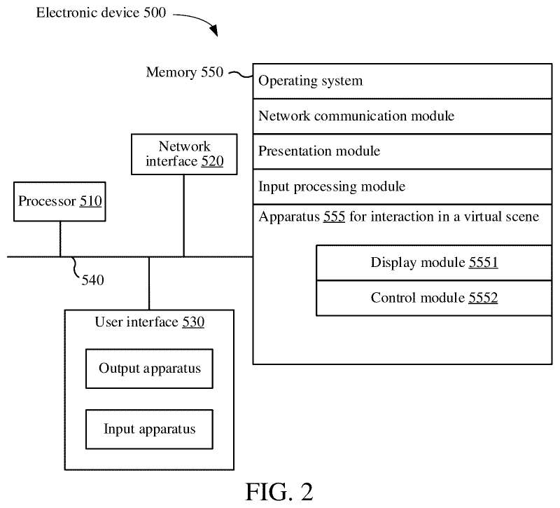

An electronic device implementing a method for interaction in a virtual scene according to an aspect described herein is described below. Referring to FIG. 2, FIG. 2 is a schematic structural diagram of an electronic device 500 implementing a method for interaction in a virtual scene according to an aspect described herein. The electronic device 500 according to the aspect described herein may be a terminal or a server. The electronic device 500 according to the aspect described herein includes at least one processor 510, a memory 550, at least one network interface 520, and a user interface 530. Various components in the electronic device 500 are coupled together through a bus system 540. The bus system 540 is configured to implement connection and communication between the components. In addition to including a data bus, the bus system 540 further includes a power bus, a control bus, and a status signal bus. However, for clarity of description, various buses in FIG. 2 are marked as the bus system 540.

In some aspects, an apparatus for interaction in a virtual scene according to an aspect described herein may be implemented by software. FIG. 2 shows an apparatus 555 for interaction in a virtual scene stored in the memory 550. The apparatus may be software in the form of a program, a plug-in, or the like, and include the following software modules: a display module 5551 and a control module 5552. These modules are logical, and therefore can be arbitrarily combined or further split according to a function to be implemented. A function of each module is described below.

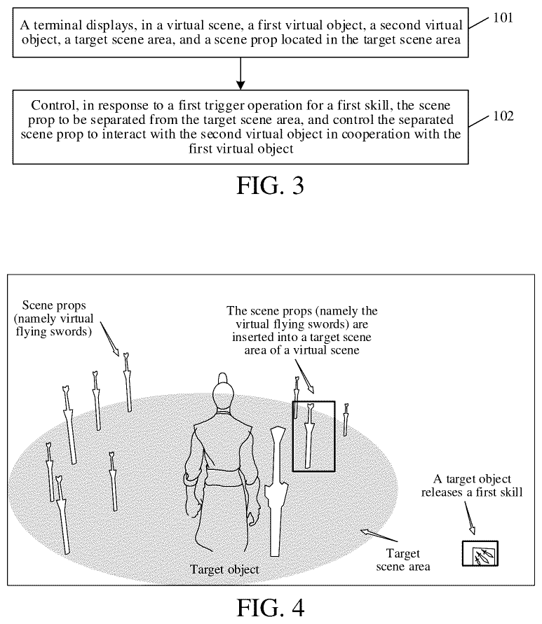

The following describes the method for interaction in a virtual scene according to the aspect described herein. In some aspects, the method for interaction in a virtual scene according to the aspect described herein may be implemented by various electronic devices, and for example, may be implemented by a terminal alone, or may be implemented by a server alone, or may be implemented by the terminal and the server collaboratively. With a terminal implementation as an example, referring to FIG. 3, FIG. 3 is a schematic flowchart of a method for interaction in a virtual scene according to an aspect described herein. The method for interaction in a virtual scene according to the aspect described herein includes the following operations:

Operation 101: A terminal displays, in the virtual scene, a first virtual object, a second virtual object, a target scene area, and a scene prop located in the target scene area.

The first virtual object has a first skill.

Herein, the terminal may run a client (such as a game client) that supports a virtual scene, and the terminal outputs the virtual scene (such as a shooting game scene or a role-playing game scene) during running of the client. For example, the terminal may obtain scene data of the virtual scene from the server, and then render the scene data, to output the virtual scene. In the aspect described herein, the terminal may display the first virtual object in the output virtual scene, and the first virtual object may be a virtual character controlled by a user entering the virtual scene. The first virtual object has the first skill. When the first virtual object releases the first skill, a skill prop may be generated. For example, the skill prop may be a virtual flying sword, a virtual bullet, a virtual arrow, a virtual bomb, or the like. In an actual application, the first skill may be owned by the first virtual object, or may be obtained by completing a target task (for example, an interaction score reaches a score threshold, a virtual monster is defeated, or a virtual resource is collected). This is not limited herein.

In addition, the terminal further displays the second virtual object in the virtual scene, and the second virtual object may be a virtual character controlled by another user entering the virtual scene, or may be a virtual object (such as a virtual monster or a virtual person) controlled by a robot program. The user may control the first virtual object and the second virtual object to interact with and confront each other. In the aspect described herein, the virtual scene has the target scene area, and there is the scene prop in the target scene area. When the first virtual object releases the first skill, the terminal may control the scene prop to be separated from the target scene area. In an actual application, types of the target scene area include, but are not limited to, the following types: a ground (such as a mud ground, a marshland, or an asphalt ground), a building, a natural object (such as a mountain or a stone), a water area, an ice layer, a snow ground, air, or the like.

In some aspects, the terminal may generate the scene prop in the following manner: The scene prop is generated in the target scene area in response to a second trigger operation for the first skill. Herein, the first virtual object may release the first skill by triggering the second trigger operation for the first skill, and generate the scene prop in the target scene area. The second trigger operation and the first trigger operation may be different or the same. For example, the terminal controls, in response to a touch and hold operation for the first skill, the first virtual object to release the first skill, to generate a skill prop (for example, a virtual flying sword) of the first skill. When the skill prop collides with the target scene area, the terminal controls the skill prop to stay in the target scene area. This is equivalent to generating the scene prop in the target scene area. In this way, the scene prop is generated by releasing the virtual skill. This enriches the diversity of skills and increases an application strategy of the skills, thereby improving interactive experience of the virtual scene.

In some aspects, a target object in the virtual scene may also generate the scene prop. For example, the target object may be the first virtual object, or may be a virtual character (such as the second virtual object, a teammate of the first virtual object, or an opponent of the first virtual object) of another user entering the virtual scene, or may be a specific virtual object (such as a virtual monster or an NPC) controlled by a robot program in the virtual scene.

In some aspects, the scene prop of the target scene area may alternatively be generated by a second skill, and the second skill is different from the first skill.

For example, the scene prop may stay in a virtual scene area (for example, the target scene area) in the virtual scene, and the virtual scene area may be a ground, an ice surface, a river surface, a mountain surface, a building surface, or the like. For example, referring to FIG. 4, FIG. 4 is a schematic diagram of display of scene props according to an aspect described herein. Herein, a target object releases a first skill in a virtual scene, to generate skill props (the skill props shown in FIG. 4 are virtual flying swords) by the first skill. The skill props stay in a target scene area of the virtual scene in a manner of being inserted into the ground, to generate the scene props in the target scene area (namely the virtual flying swords staying in the target scene area).

Operation 102: Control, in response to a first trigger operation for the first skill, the scene prop to be separated from the target scene area, and control the separated scene prop to interact with the second virtual object in cooperation with the first virtual object.

Herein, the terminal receives the first trigger operation for the first skill of the first virtual object. The first trigger operation may be a release operation (for controlling the first virtual object to release the first skill), and may be triggered by a control for the first skill. The terminal controls the scene prop to be separated from the target scene area in response to the first trigger operation, so that when controlling the first virtual object to interact with and confront the second virtual object, the terminal may control the scene prop to interact with and confront the second virtual object in cooperation with the first virtual object.

In some aspects, the terminal may control the separated scene prop to interact with the second virtual object in cooperation with the first virtual object by performing the following operations: controlling the separated scene prop to be transmitted toward the second virtual object; and reducing an attribute value of an object attribute of the second virtual object when the separated scene prop hits the second virtual object.

Herein, after the scene prop is separated from the target scene area, the terminal may further control the scene prop to be transmitted toward the second virtual object, to control the first virtual object to interact with and confront the second virtual object. When the scene prop hits the second virtual object, the attribute value of the object attribute of the second virtual object may be reduced. The object attribute may include a blood volume, a speed, a restoration capability, an attacking force, and the like. For example, when the separated scene prop is transmitted, movement of the scene prop may be controlled according to a prop movement parameter of the first skill until the second virtual object is hit. The prop movement parameter may include a movement (or referred to as flight) track (such as a straight line, a line segment, or a Bezier curve), a speed, duration, or the like.

In some aspects, the terminal may control the separated scene prop to interact with the second virtual object in cooperation with the first virtual object by performing the following operations: controlling the separated scene prop to be arranged around the first virtual object according to a formation of a target shape; and controlling, when the first virtual object is attacked by the second virtual object, the separated scene prop to eliminate a negative impact of the attack on the first virtual object.

Herein, after the scene prop is separated from the target scene area, the terminal may control the scene prop to be arranged around the first virtual object according to the formation of the target shape. The target shape includes, but is not limited to, a circle, a square, a triangle, or the like. During interaction and confrontation between the first virtual object and the second virtual object, the scene prop may be configured to eliminate a negative impact caused by an attack performed by the second virtual object on the first virtual object. For example, a target quantity of scene props can eliminate a negative impact of one attack on the first virtual object. The target quantity may be preset. For example, the target quantity may be one or more. The target quantity for eliminating a negative impact caused by different types of attacks may alternatively be different, that is, the target quantity may be determined according to types of attacks. In this way, by invoking of the scene prop existing in the target scene area, a defense effect in interaction and confrontation is achieved, interactive manners in the virtual scene are increased, and interaction experience in the virtual scene is improved.

In some aspects, the terminal device may perform the following processing: displaying skill release prompt information of the scene prop, where the skill release prompt information is configured for prompting that a scene prop that can be separated from the target scene area exists in the virtual scene.

Herein, the terminal may display the skill release prompt information, and the skill release prompt information is configured for prompting that a scene prop that can be separated from the target scene area exists in the virtual scene. In an actual application, the skill release prompt information may be displayed in at least one of the following occasions: occasion 1): a scene prop exists in the virtual scene; occasion 2): a skill prop exists within a sensing range of the first virtual object; and occasion 3): a skill prop generated by releasing the first skill by a target virtual object having a target relationship with the first virtual object exists in the virtual scene. The target relationship may include at least one of the following: 1) the target virtual object and the first virtual object are in the same camp; 2) the target virtual object is an auxiliary object of the first virtual object, for example, an NPC such as a person or an animal that follows an action of the first virtual object; and 3) there is a social relationship, such as friends, between a player account of the target virtual object and a player account of the first virtual object. In an actual application, the skill release prompt information may further prompt a location of the target scene area, so that the user controls the first virtual object to move to a corresponding location to release the first skill. In this way, corresponding skill release prompt information can be displayed when a scene prop exists in the virtual scene, to prompt the user that interaction may be performed by invoking the scene prop, thereby enriching interactive manners in the virtual scene, and improving interaction efficiency.

In some aspects, a plurality of scene props are provided; and the terminal may receive a release instruction of the first skill in the following manner: a pressing operation on a skill control for the first skill is received; a quantity of to-be-separated scene props among the plurality of scene props is adjusted during execution of the pressing operation; and a first trigger operation for the first skill is received, and an adjusted target quantity of the to-be-separated scene props when the pressing operation is released is determined, in response to that the pressing operation is released, the target quantity being less than or equal to the quantity of the scene props. Correspondingly, the terminal may control the scene prop to be separated from the target scene area in the following manner: the target quantity of scene props are controlled to be separated from the target scene area.

Herein, the terminal is provided with the skill control configured to release the first skill. By pressing of the skill control, the quantity of to-be-separated scene props invoked from the virtual scene may be adjusted. The adjustment process is an accumulation process. With execution of the pressing operation, the quantity of to-be-separated scene props is continuously accumulated, and an accumulation speed may be preset. For example, 2 to-be-separated scene props are accumulated per second. The terminal may further display a process of accumulation of to-be-separated scene props, and for example, display a process of change in a quantity of to-be-separated scene props, or display a process of gradual increasing of to-be-separated scene props. When the pressing operation on the skill control is released, the first trigger operation for the first skill is received, and the adjusted target quantity of to-be-separated scene props when the pressing operation is released, namely a quantity of to-be-separated scene props accumulated when the pressing operation is released, is further determined. Based on this, the terminal may control the target quantity of scene props to be separated from the target scene area. An execution process of the pressing operation may be understood as an accumulation stage of the first skill, that is, a quantity of to-be-separated scene props invoked from the virtual scene is accumulated. In this way, the quantity of to-be-separated scene props is controlled by the pressing operation, thereby increasing interactive manners in the virtual scene, and improving interaction efficiency.

The skill control has an active state and a cooled state. When the skill control is in the active state, the skill control is available, and the release instruction of the first skill may be triggered by the skill control. When the skill control is in the cooled state, the skill control is unavailable. The cooled state has a corresponding cooling duration threshold. When cooling duration during which the skill control is in the cooled state reaches the cooling duration threshold, the skill control is controlled to switch from the cooled state to the active state. In an actual application, the skill control may alternatively be activated by controlling the first virtual object to complete a target task (for example, an interaction score reaches a score threshold, a virtual monster is defeated, or a virtual resource is collected).

In some aspects, the terminal may control the scene prop to be separated from the target scene area in the following manner: when a plurality of scene props are provided, a to-be-separated scene prop located in a sensing area of the first virtual object is determined, the plurality of scene props including the to-be-separated scene prop; and the to-be-separated scene prop is controlled to be separated from the target scene area. The sensing area of the first virtual object may be: a two-dimensional planar area of a target shape (such as a circle, a square, a rectangle, or a triangle) centered on the first virtual object, or a three-dimensional space of a target three-dimensional structure (such as a spherical structure or a cube structure) centered on the first virtual object. In this way, the to-be-separated scene prop may be automatically determined according to the location of the first virtual object with no need for selection by a user, thereby improving interaction efficiency of the virtual scene.

In some aspects, the terminal may control the scene prop to be separated from the target scene area in the following manner: when a plurality of scene props are provided, a to-be-separated scene prop transmitted by a target virtual object by releasing the first skill is determined, where the plurality of scene props include the to-be-separated scene prop, and a target relationship exists between the target virtual object and the first virtual object; and the to-be-separated scene prop is controlled to be separated from the target scene area. The target relationship may include at least one of the following: 1) the target virtual object and the first virtual object are in the same camp; 2) the target virtual object is an auxiliary object of the first virtual object, for example, an NPC such as a person or an animal that follows an action of the first virtual object; and 3) there is a social relationship, such as friends, between a player account of the target virtual object and a player account of the first virtual object. In this way, the to-be-separated scene prop may be automatically determined according to the relationship between the target virtual object and the first virtual object, without a need for selection by the user, thereby improving interaction efficiency of the virtual scene.

In some aspects, the terminal can further generate a skill prop in response to a first trigger operation for the first skill (namely when the first virtual object releases the first skill). Therefore, after controlling the scene prop to be separated from the target scene area, the terminal may control the scene prop and the first virtual object to cooperate with interaction between the first virtual object and the second virtual object by releasing the skill prop generated by the first skill. For example, the scene prop may be controlled to be transmitted in cooperation with the skill prop generated by the first virtual object by releasing the first skill, so that the scene prop and the skill prop are both configured to interact with and confront the second virtual object in cooperation with the first virtual object. In an actual application, an effect of the first skill may be positively correlated to a quantity of transmitted virtual props (including scene props and skill props). Therefore, according to the aspect described herein, a maximum quantity of virtual props transmitted by the first skill at a time may be increased, thereby enhancing the effect of the first skill and improving interaction efficiency of the virtual scene.

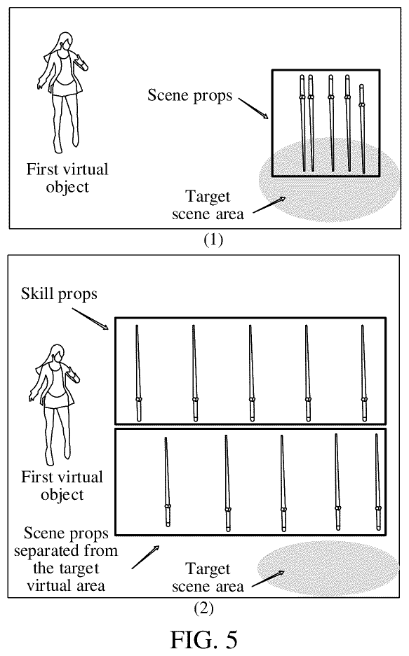

In an example, referring to FIG. 5, FIG. 5 is a schematic diagram of transmission of virtual props according to an aspect described herein. Herein, the virtual props (including scene props and skill props) are virtual flying swords. As shown in (1) in FIG. 5, the scene props are inserted into a ground of a virtual scene. As shown in (2) in FIG. 5, when a first virtual object releases a first skill, the scene props leave the ground of the virtual scene, and the scene props are transmitted together with the skill props generated by the first virtual object by releasing the first skill.

In some aspects, the terminal may further display a skill prop generated by the first virtual object by releasing the first skill. Correspondingly, after controlling the scene prop to be separated from a target scene area, the terminal may display a process of merging of the separated scene prop and the skill prop. When the merging of the separated scene prop and the skill prop ends, the scene prop and the skill prop that are merged are controlled to be transmitted.

Herein, the terminal can further generate the skill prop in response to the first trigger operation for the first skill (namely when the first virtual object releases the first skill). Therefore, the terminal may display the skill prop generated by the first virtual object by releasing the first skill. In some aspects, the terminal may display, in the following manner, a skill prop generated by the first virtual object by releasing the first skill: when a plurality of skill props are provided, a plurality of skill props that are generated by the first virtual object by releasing the first skill and that are arranged according to a formation of a target shape are displayed. The target shape may be a square, a circle, a rectangle, a triangle, a semi-circle, or the like. The plurality of skill props arranged according to the formation may be located around the first virtual object. The first virtual object may be surrounded by the plurality of skill props arranged according to the formation. The first virtual object may alternatively be located on a side, such as a left side, a right side, an upper side, or a lower side, of the plurality of skill props arranged according to the formation.

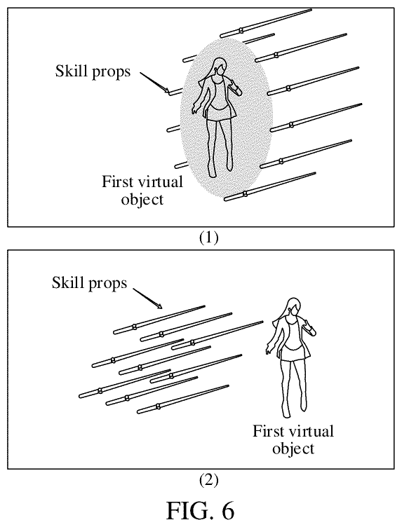

Referring to FIG. 6, FIG. 6 is a schematic diagram of display of skill props according to an aspect described herein. Herein, the skill props are virtual flying swords. As shown in (1) in FIG. 6, a plurality of skill props are arranged according to a circular formation, and a first virtual object is surrounded by the plurality of skill props arranged according to the circular formation. As shown in (2) in FIG. 6, a plurality of skill props are arranged according to a 3*3 square matrix formation, and the first virtual object is located on a side (namely a left side) of the plurality of skill props arranged according to the square matrix formation.

Then, the terminal displays a process of merging separated scene props and the skill props, namely a process in which the scene props are separated from the target scene area and then move to be around a position of the skill props. When the merging of the separated scene props and the skill props ends, the first virtual object may be controlled to transmit the scene props in cooperation with the skill props generated by the first virtual object by releasing the first skill. In some aspects, the terminal may display, in the following manner, the process of merging the scene props and the skill props: according to a formation adding rule, a process of adding the scene props to the plurality of skill props arranged according to the formation of the target shape is displayed, to merge the scene props and the skill props.

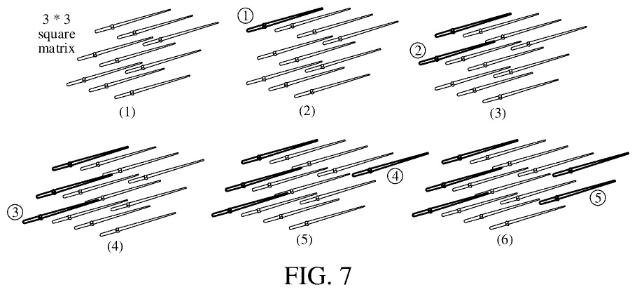

Herein, the formation adding rule may be preset. For example, the skill props are arranged according to an M*N square matrix, and the formation adding rule may be that scene props are added in columns without rows, first to the left and then to the right, and first to the top and then to the bottom, or that scene props are added in rows without columns, first to the top and then to the bottom, and first to the left and then to the right. The skill props are arranged according to a circular formation, and the formation adding rule may be that circle layers of a circle are expanded outward and increased and the scene props are sequentially added from a target orientation in a clockwise (or counterclockwise) direction. For example, referring to FIG. 7, FIG. 7 is a schematic diagram of a process of merging of skill props and scene props according to an aspect described herein. Hercin, as shown in (1) in FIG. 7, the skill props are arranged in a 3 (rows)*3 (columns) square matrix formation. Five to-be-merged scene props (virtual flying swords shown by bold lines in FIG. 7) are sequentially merged into the square matrix formation in a manner of being sequentially merged into upper left \textcircled{1} (as shown by (2) in FIG. 7), middle left \textcircled{2} (as shown by (3) in FIG. 7), lower left \textcircled{3} (as shown by (4) in FIG. 7), upper right \textcircled{4} (as shown by (5) in FIG. 7), and middle right \textcircled{5} (as shown by (6) in FIG. 7).

By application of the above-mentioned aspect, the maximum quantity of virtual props (including scene props of the target scene area and skill props generated by releasing the first skill) transmitted by the first skill at a time may be increased, thereby enhancing an effect of the first skill, and improving interaction efficiency of the virtual scene. In addition, the separated scene props and skill props are merged according to a display formation of the skill props and the formation adding rule, thereby improving scene experience of the virtual scene.

In some aspects, the terminal device may perform the following processing: displaying target merging duration during which the separated scene prop and the skill prop are merged; and correspondingly, determining, when the target merging duration reaches a merging duration threshold, that the merging of the separated scene prop and the skill prop ends. Herein, the merging duration threshold may be preset, such as 3 seconds. When the target merging duration of the scene props and the skill props reaches the merging duration threshold, it is determined that the merging of the scene props and the skill props ends.

In some aspects, the terminal device may perform the following processing: obtaining a prop movement parameter for the first skill; and controlling the scene prop and the skill prop that are transmitted to move in the virtual scene according to the prop movement parameter. Herein, the prop movement parameter may include a movement (or referred to as flight) track (such as a straight line, a line segment, or a Bezier curve), a speed, duration, or the like. After the scene prop and the skill prop are transmitted, the scene prop and the skill prop move according to the prop movement parameter. In this way, an interactive effect of the virtual scene is improved by controlling a movement status of the scene prop and the skill prop that are transmitted.

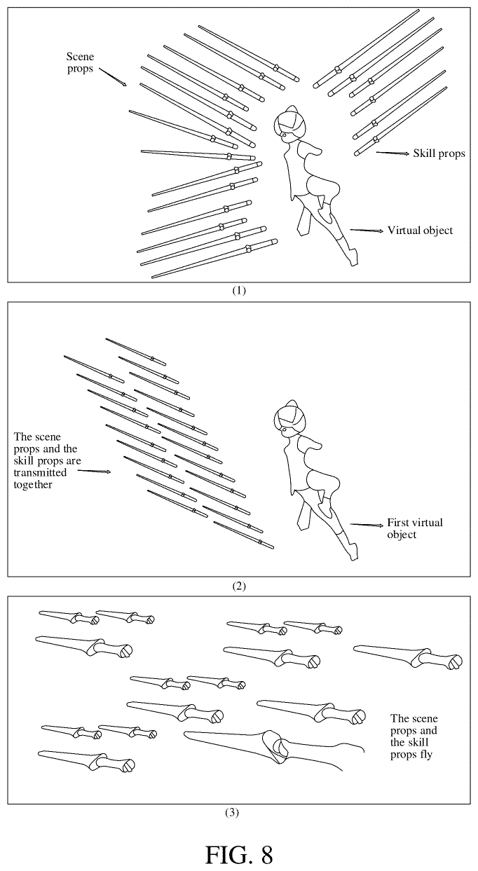

In an example, referring to FIG. 8, FIG. 8 is a schematic diagram of transmission of virtual props according to an aspect described herein. Herein, the virtual props (including scene props and skill props) are all virtual flying swords. As shown in (1) in FIG. 8, scene props and skill props are merged and then displayed around a first virtual object. As shown in (2) in FIG. 8, the scene props and the skill props are transmitted together. As shown in (3) in FIG. 8, the scene props and the skill props fly in a virtual scene.

In some aspects, the terminal device may perform the following processing: determining a collision target of a transmitted target virtual prop in the virtual scene, the target virtual prop including the scene prop and the skill prop; and controlling the target virtual prop to stay in a virtual scene area of a first type when the collision target is the virtual scene area of the first type, where the target virtual prop staying in the virtual scene area of the first type is configured to control the target virtual prop to be separated from the virtual scene area when a first trigger operation for the first skill is received.

Herein, when controlling the target virtual prop (including the scene prop and the skill prop) to move in the virtual scene, the terminal collides with a target in the virtual scene. A collision target of the target virtual prop in the virtual scene is determined when the target virtual prop collides with the target in the virtual scene. The target virtual prop is controlled to stay in a virtual scene area of a first type if the collision target is the virtual scene area of the first type. For example, the virtual scene area may be a ground (a mud ground, a marshland, an asphalt ground, or the like), a water area, a building, a natural object (such as a mountain or a stone), an ice layer, a snow ground, air, or the like. Types of the virtual scene area include, but are not limited to, the following types: a ground (such as a mud ground, a marshland, or an asphalt ground), a building, a natural object (such as a mountain or a stone), a water area, an ice layer, a snow ground, air, or the like. The first type may be at least one of the above-mentioned types.

The target virtual prop staying in the virtual scene area of the first type may control the target virtual prop to be separated from the virtual scene area when a first trigger operation for the first skill is received, so that the target virtual prop separated from the virtual scene area may be controlled to interact with the second virtual object in cooperation with the first virtual object. The target virtual prop may stay in the virtual scene area of the first type in a manner such as insertion, suspension, hanging, or pasting. In this way, when the target virtual prop is transmitted to interact with the second virtual object, the target virtual prop that does not hit the second virtual object may stay in the virtual scene, so that when the first skill is released again, the target virtual prop may be separated from the virtual scene area to interact with the second virtual object in cooperation with the first virtual object, and a maximum quantity of virtual props (including target virtual props in the virtual scene area and skill props generated by releasing the first skill) transmitted by the first skill at a time is increased, thereby enhancing an effect of the first skill, and improving interaction efficiency of the virtual scene.

In some aspects, after controlling the target virtual prop to stay in the virtual scene area of the first type, the terminal may perform the following processing: controlling the virtual scene area of the first type to be converted into a virtual scene area of a second type, where the virtual scene area of the second type is configured to adjust an attribute value of an object attribute of a target virtual object in the virtual scene area of the second type.

Herein, after the target virtual prop is controlled to stay in the virtual scene area of the first type, the virtual scene area of the first type may be further converted into the virtual scene area of the second type. The second type may be a type among the types of the virtual scene areas that is different from the first type, and the second type may be related to the first type. For example, the first type and the second type belong to the same first general type. For example, if the first general type is a ground, a first type “asphalt ground” may be converted into a second type “marshland”. For another example, if the first general type is a water type, a first type “river water surface” may be converted into a second type “ice surface”. The virtual scene area of the second type may be further configured to adjust an attribute value of an object attribute of a target virtual object in the virtual scene area of the second type. For example, when the target virtual object is located in the virtual scene area of the second type, the attribute value of the object attribute of the target virtual object may be adjusted, and the adjustment includes positive adjustment and negative adjustment. When the target virtual object and the first virtual object belong to the same camp, the adjustment may be positive adjustment, for example, increasing a blood volume, increasing a speed, or increase an attacking force. When the target virtual object and the first virtual object belong to antagonist camps, the adjustment may be negative adjustment, for example, reducing the blood volume, reducing the speed is reduced, or reducing the attacking force. Herein, the object attribute may include a blood volume, a speed, a restoration capability, an attacking force, and the like. In this way, the target virtual prop staying in the virtual scene may further convert a type of the virtual scene area, thereby enriching interactive manners in the virtual scene, and improving interaction efficiency in the virtual scene.

In some examples, the target virtual prop staying in the virtual scene area of the second type may also be configured to control the target virtual prop to be separated from the virtual scene area when a first trigger operation for the first skill is received, so that the target virtual prop separated from the virtual scene area may be controlled to interact with the first virtual object and the second virtual object.

In some aspects, the terminal device may perform the following processing: controlling the target virtual prop to disappear from the virtual scene, and controlling the virtual scene area of the second type to be converted into the virtual scene area of the first type, when duration during which the target virtual prop stays in the virtual scene area reaches a duration threshold. Herein, the duration threshold may be preset. The target virtual prop is controlled to disappear from the virtual scene, and the virtual scene area of the second type is also controlled to be converted into the virtual scene area of the first type, when duration during which the target virtual prop stays in the virtual scene area reaches the duration threshold. Certainly, in some aspects, the target virtual prop staying in the virtual scene area may alternatively not be limited by the duration threshold, and for example, may always exist in the virtual scene in a certain degree (for example, one interaction turn of the virtual scene).

In some aspects, the terminal device may perform the following processing: controlling the virtual scene area of the second type to be converted into the virtual scene area of the first type after the target virtual prop is separated from the virtual scene area. Similarly, the virtual scene area of the second type may also be converted into the virtual scene area of the first type after the target virtual prop is separated from the virtual scene area.

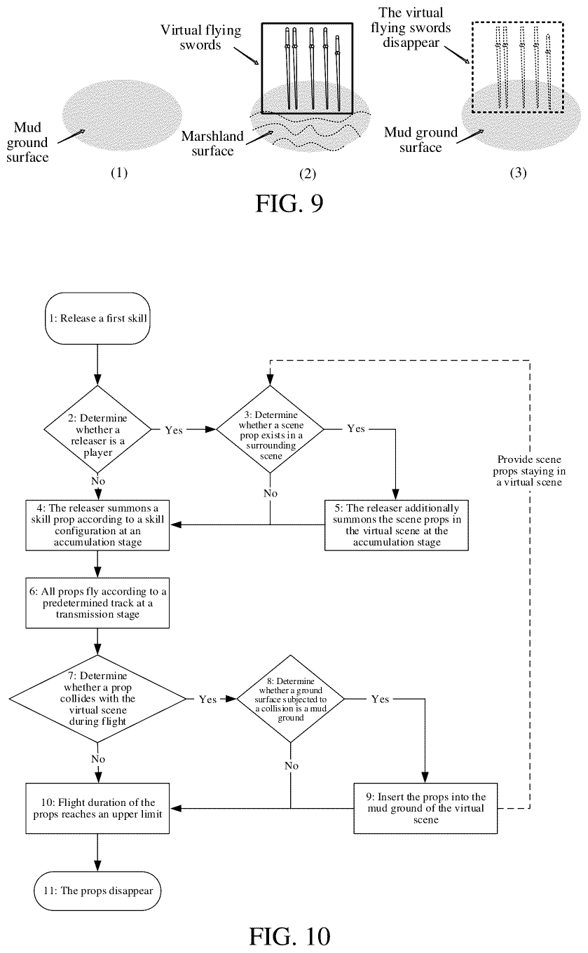

For example, referring to FIG. 9, FIG. 9 is a schematic diagram of conversion of a virtual scene area according to an aspect described herein. Herein, as shown in (1) in FIG. 9, the virtual scene area is a mud ground surface with no target virtual props (namely virtual flying swords) staying. As shown in (2) in FIG. 9, virtual flying swords are inserted into the virtual scene area, and in this case, the virtual scene area is converted from a mud ground surface into a marshland ground surface. As shown in (3) in FIG. 9, virtual flying swords inserted into the virtual scene area disappear, that is, the virtual flying swords are separated from the virtual scene area. In this case, the virtual scene area is converted from the marshland ground surface to the mud ground surface.

In some aspects, the terminal device may perform the following processing: determining a collision target of a transmitted target virtual prop in the virtual scene, the target virtual prop including the scene prop and the skill prop; and controlling the target virtual prop to disappear from the virtual scene when the collision target is a virtual scene area of a third type. The third type is a type among the types of the virtual scene areas that is different from the second type and the first type. In this way, the target virtual prop colliding with the virtual scene area of the third type may be controlled to disappear. In this case, the target virtual prop cannot be invoked by the first skill, and interactive manners in the virtual scene may be increased, so that interaction in the virtual scene is more strategic.

In some aspects, the terminal device may perform the following processing: determining a collision target of a transmitted target virtual prop in the virtual scene, the target virtual prop including the scene prop and the skill prop; and adjusting an attribute value of an object attribute of the target virtual object when the collision target is the target virtual object.

Herein, when controlling the target virtual prop (including the scene prop and the skill prop) to move in the virtual scene, the terminal collides with a target in the virtual scene. A collision target of the target virtual prop in the virtual scene is determined when the target virtual prop collides with the target in the virtual scene. An attribute value of an object attribute of the target virtual object is adjusted if the collision target is the target virtual object. The adjustment herein includes positive adjustment and negative adjustment. When the target virtual object and the first virtual object belong to the same camp, the adjustment may be positive adjustment, for example, increasing a blood volume, increasing a speed, or increase an attacking force. When the target virtual object and the first virtual object belong to antagonist camps, the adjustment may be negative adjustment, for example, reducing the blood volume, reducing the speed is reduced, or reducing the attacking force. Herein, the object attribute may include a blood volume, a speed, a restoration capability, an attacking force, and the like. In this way, the target virtual prop is transmitted to the target virtual object, so that the target virtual prop is controlled to interact with the second virtual object in cooperation with the first virtual object, thereby improving interaction efficiency of the virtual scene.

In some aspects, after adjusting the attribute value of the object attribute of the target virtual object, the terminal may perform the following processing: controlling the target virtual prop to penetrate the target virtual object, and controlling the target virtual prop to continue to move; and executing, when the moving target virtual prop collides with a scene target of the virtual scene again, processing logic matching the scene target on the scene target.

Herein, after adjusting the attribute value of the object attribute of the target virtual object, the terminal may further control the target virtual prop to penetrate the target virtual object, and control the target virtual prop to continue to move. A maximum quantity of target virtual objects that can be penetrated may be preset. When the quantity of the penetrated target virtual objects does not exceed a quantity threshold, the target virtual prop may continue to move. In some examples, as the penetrated target virtual objects increase, a movement speed of the target virtual prop may also change. For example, the movement speed decreases. When the moving target virtual prop collides with the scene target in the virtual scene again, processing logic matching the scene target is executed on the scene target. Specifically, the scene target may be the virtual scene area of the first type, the virtual scene area of the third type, or the target virtual object, and then the corresponding scene target may be processed by processing logic provided in the above-mentioned aspect for that the collision target is the virtual scene area of the first type, the collision target is the virtual scene area of the third type, or the collision target is the target virtual object. Details are not described herein. In this way, the target virtual prop may further penetrate the target virtual object to move, to continue to collide with another target to execute corresponding logic, thereby further enriching interactive manners in the virtual scene, and improving an interactive effect and interaction efficiency in the virtual scene.

In some aspects, the collision target may alternatively be converted into the virtual scene area of the second type, and in this case, the target virtual prop may be controlled to also stay in the virtual scene area of the second type.

In some aspects, the target virtual prop includes a plurality of virtual subprops, and the terminal may adjust the attribute value of the object attribute of the target virtual object in the following manner: an adjusted value of one virtual subprop for the attribute value and a target quantity of the virtual subprops are obtained; and the attribute value of the object attribute of the target virtual object is adjusted based on the target quantity and the adjusted value. Herein, one virtual subprop has a corresponding adjusted value for the attribute value. When the target quantity of virtual subprops collide with the target virtual object, the attribute value of the object attribute of the target virtual object may be adjusted by the following size: total adjusted value=adjusted value*target quantity.

In some aspects, the terminal device may perform the following processing: controlling the target virtual prop to disappear from the virtual scene when duration during which the target virtual prop stays in the virtual scene reaches a stay duration threshold, where the target virtual prop includes a scene prop and a skill prop. In an actual application, no matter whether the target virtual prop collides with the target in the virtual scene, the target virtual prop may also be controlled to disappear from the virtual scene when the duration during which the target virtual prop stays in the virtual scene reaches the stay duration threshold. In this way, a waste of display resources and device processing resources can be reduced, and resource utilization can be improved.

An illustrative application of the aspect described herein in an actual application scene is described below. Herein, the virtual scene is a massive (or massively) multiplayer online role-playing game (MMORPG) scene. A first virtual object controlled by a player, a third virtual object controlled by a teammate, a second virtual object controlled by an interaction opponent, and a monster virtual object (controlled by a robot program) may all fly in air in the virtual scene.

In an actual application, a terminal corresponding to a player account that controls the first virtual object may display a virtual picture corresponding to a virtual scene. The virtual scene includes a plurality of different virtual scene areas (for example, soil, a river, a marsh, and a mountain). Virtual objects in the virtual scene may all have a skill (the above-mentioned first skill) of “physical flying sword”. A terminal interface further displays a first skill control corresponding to the first skill. When it is detected that a single tap operation (the above-mentioned second trigger operation) is performed on the first skill control and the first virtual object is controlled to release the skill, flying swords (the above-mentioned skill props) may be transmitted in the air. After the flying swords hit the target in the virtual scene, a corresponding operation may be performed. For example, when the flying swords penetrate a virtual object of a antagonist party, the virtual object of the antagonist party may be damaged. When the flying swords hit the virtual scene area, if the virtual scene area is of the first type (for example, a mud ground), the flying swords may be controlled to be inserted into the virtual scene area, and physical flying swords (the above-mentioned scene props) are formed in the virtual scene area. In this case, the virtual scene area is converted from the first type into a second type (for example, a marshland), and a corresponding scene effect is displayed. If the virtual scene area is of the third type (for example, a mountain), the flying swords are controlled to disappear from the virtual scene.

Further, with an example in which the virtual scene area is a ground, when the quantity of physical flying swords inserted into the ground is greater than a quantity threshold, a prompt special effect of accumulation of the flying swords may be displayed on the first skill control, and the quantity of the physical flying swords may also be displayed on the first skill control. By the prompt special effect, a player can be prompted that the physical flying sword skill may be released to invoke the physical flying swords inserted in the ground, so as to accumulate the quantity of flying swords transmitted by the physical flying sword skill. When it is detected that a touch and hold operation is performed on the first skill control, the first virtual object is controlled for accumulation, and accumulation duration may be determined according to a quantity of physical flying swords. When the accumulation ends and it is detected that a release operation is performed on the first skill control (the touch and hold operation in combination with the release operation is the above-mentioned first trigger operation), the physical flying swords in the ground and the flying swords generated by the first virtual object by releasing the physical flying sword skill are controlled to be transmitted together, to interact with and confront the virtual object of the opponent. Hercin, a larger quantity of transmitted flying swords indicates higher damage caused to the virtual object of the opponent. In some aspects, the physical flying swords in the ground may disappear after the attack ends, and the flying swords generated by the player by releasing the physical flying sword skill may further land on the ground to generate the physical flying swords, for invoking when the physical flying sword skill is subsequently released.

The trigger operation in the aspect described herein includes, but is not limited to an operation such as tap, double tap, touch and hold, or swipe. The control in the aspect described herein may be equivalent to a function item, and may have a plurality of presentation forms, such as a graphical button, a progress bar, a menu, and a list. This is not limited in the aspect described herein. A user or player mentioned in the aspect described herein may be an object corresponding to an account currently logged in to at a client, or may be an object using a current client when the client is not currently logged in to.

In application of the above-mentioned aspects described herein, the first virtual object, the second virtual object, the target scene area, and the scene prop located in the target scene area are displayed in the virtual scene, and when the first trigger operation for the first skill is received, the scene prop is controlled to be separated from the target scene area, so that the separated scene prop is controlled to interact with the second virtual object in cooperation with the first virtual object. Herein, the scene prop is provided in the target scene area of the virtual scene. If the first virtual object triggers the first skill during interaction, the scene prop of the target scene area can be invoked to interact with the second virtual object in cooperation with the first virtual object. In this way, the target scene area of the virtual scene provides the scene prop for the first skill to invoke, and application manners of a virtual skill in the virtual scene can be enriched, thereby improving efficiency of interaction control of the virtual scene, and improving utilization of hardware processing resources. 2) The diversity of skills can be enriched, and an application strategy of the skills can be increased, thereby improving interaction experience of the virtual scene.

An illustrative application of the aspect described herein in an actual application scene is described below with an example in which a virtual scene is a game scene. In a game scene in the related technology, when a player controls a virtual object to release a first skill, if the first skill is released at a scene location in the virtual scene, the first skill can only make a unidirectional change to the virtual scene and then a skill effect disappears. For example, if a freezing skill is released, freezing is implemented only at a corresponding scene location in the virtual scene. In this way, application scenes of the first skill are limited.

Based on this, in the aspect described herein, a first skill of a ballistic type (that is, a skill prop (such as a virtual flying sword, a virtual throwing knife, virtual lightning, or a virtual arrow) can be generated) is provided at a level of linkage between the virtual scene and the first skill. After such a first skill is released, a corresponding skill prop may be generated (as shown in FIG. 4, the skill props are virtual flying swords), and the skill prop may move to a corresponding target according to a specific track. If a final landing point of the skill prop is a virtual scene area of a first type (for example, a mud ground), the skill prop may be inserted into the virtual scene area of the first type in the virtual scene to obtain a scene prop, and the virtual scene area of the first type is changed to a virtual scene area of a second type (for example, a marshland). In addition, when a virtual object releases a first skill of this type, the first skill may be transmitted together with a scene prop in a virtual scene area within a target range (for example, a sensing area of the virtual object), thereby amplifying an original skill effect (for example, an attack effect for the target virtual object) of the first skill. In this way, by the first skill of this type, in addition to enabling the first skill to affect the virtual scene, the virtual scene may also affect the first skill in turn. Based on this, a richer game interaction strategy may be generated, and interaction experience of a more three-dimensional virtual scene may be provided.

(I) An impact of the first skill on the virtual scene is described.

1. An impact, on the virtual scene, of controlling a virtual object by a player to release the first skill includes the following:
a) The player controls the virtual object to release the first skill, to generate and transmit a corresponding skill prop, and the transmitted skill prop flies according to a specific track. As shown in FIG. 4, the specific track of the skill prop is a falling track from top to bottom. If a target (or referred to as a landing point) hit by the skill prop is a target virtual object, a corresponding gain or damage may be caused to the target virtual object. For example, when the target virtual object and the virtual object belong to antagonist camps, the skill prop may damage the target virtual object.
b) If the target hit by the skill prop is a virtual scene area of a first type (for example, a mud ground), the skill prop may change into a physical state and be inserted into the virtual scene area of the first type, to obtain a scene prop. In an actual application, the scene prop inserted into the virtual scene area of the first type may stay all the time, or may disappear after set duration. In addition, the virtual scene area of the first type in which the scene prop is inserted may be converted into a virtual scene area of a second type (for example, a marshland). Moreover, when the target virtual object is located in the virtual scene area of the second type, a corresponding gain or damage is caused to the target virtual object. For example, when the target virtual object and the virtual object belong to antagonist camps, the virtual scene area of the second type may damage the target virtual object.
c) If the target hit by the skill prop is a virtual scene area of a third type (for example, a non-mud ground surface such as a rock or a mountain), the skill prop may directly disappear.

2. An impact of releasing the first skill by a specific virtual object (for example, a monster controlled by a robot program in a game scene) on the virtual scene includes the following:
a) If the specific virtual object releases the first skill, and a target (or referred to as a landing point) hit by a transmitted skill prop is a virtual object, the virtual object may be damaged.
b) If the specific virtual object releases the first skill, and the target hit by the transmitted skill prop is a virtual scene area of a first type (for example, a mud ground), the skill prop may change into a physical state and be inserted into the virtual scene area of the first type, to obtain a scene prop. In addition, the virtual scene area of the first type in which the scene prop is inserted may be converted into a virtual scene area of a second type (for example, a marshland). Moreover, when the virtual object is located in the virtual scene area of the second type, the virtual object may be damaged.

3. Restoration of the virtual scene includes the following:
a) After the scene prop inserted into the virtual scene area is absorbed and transmitted by the released first skill, the virtual scene area of the second type is restored to the virtual scene area of the first type.
b) When existence duration of the scene prop inserted into the virtual scene area reaches a duration threshold, the scene prop may disappear to restore the virtual scene.

(II) An impact of the virtual scene on the first skill is described.

1. When the virtual object releases the first skill, the first skill may be transmitted together with the scene prop inserted into the virtual scene area in the sensing area of the virtual object and the skill prop generated when the first skill is released, to enhance a skill effect of the first skill.

2. A process of releasing the first skill includes the following:
a) Attraction of scene props: As shown in FIG. 5, when the virtual object releases the first skill, the scene props inserted into the sensing area of the virtual object are invoked.
b) Gathering of the scene props: As shown in FIG. 5, at an accumulation and transmission stage of the first skill, indexed scene props may all be gathered around the virtual object according to a preset track (for example, an arc-shaped track) within preset duration (for example, 0.2 second).
c) Transmission of the scene props: As shown in FIG. 8, at a transmission stage of the first skill, in addition to skill props generated when the first skill is released, attracted scene props in the virtual scene are also transmitted together according to the same track, to enhance a skill effect of the first skill at this time. For example, a larger quantity of transmitted target virtual props (including skill props and scene props) indicates higher damage caused to the target.

The method for interaction in a virtual scene according to the aspect described herein is described in detail below with reference to FIG. 10. The method for interaction in a virtual scene according to the aspect described herein includes the following operations:

1: Release a first skill. 2: Determine whether a releaser is a player, and if yes, perform operation 3, or if not, perform operation 4. 3: Determine whether a scene prop generated when the first skill is released exists in a sensing area of the releaser, and if yes, perform operation 5, or if not, perform operation 4. 4: The releaser summons a skill prop according to a skill configuration at an accumulation stage. 5: The releaser additionally absorbs the scene props in the virtual scene at the accumulation stage. 6: All props (including the skill prop and the scene prop) fly according to a predetermined track at a transmission stage. 7: Determine whether a prop collides with the virtual scene during flight, and if yes, perform operation 8, or if not, perform operation 10. 8: Determine whether the ground surface subjected to a collision is a mud ground, and if yes, perform operation 9, or if not, perform operation 10. 9: Insert the props into the mud ground of the virtual scene, to provide scene props in the virtual scene. 10: Flight duration of the props reaches an upper limit. 11: The props disappear.

Next, the first skill is described in detail.

I. Basic logic of the first skill.

1. A definition of the first skill includes the following: a) A special effect of skill prop transmission: ID 1000 is newly added. b) If a skill ballistic invokes ID 1000, the first skill is a first skill of a skill prop transmission type. c) A quantity and a flight track of skill props transmitted when the first skill is released are separately configured by a skill editor (such as a timeline). d) Damage of a single skill prop may be fixed, and a larger quantity of hits by skill props indicates higher damage caused by the first skill.

2. A process of releasing the first skill includes the following:
a) Begin to release.

When a releasing body releases the first skill, whether the releasing body is a virtual object of a player or a specific virtual object (for example, a monster controlled by a robot program in a game scene) is first determined.
a1) Execute conventional accumulation logic if the releasing body is a specific virtual object.
a2) Retrieve a special effect of scene props if the releasing body is a virtual object of a player, to determine whether a special effect of scene props of ID 1000 exists within a spherical range of a radius X meters (X is a configuration value of the first skill) with the virtual object of the player as a center.
a2.1) If not, execute conventional accumulation logic.
a2.2) If yes, first execute scene prop absorption logic and then execute conventional accumulation logic.

The scene prop absorption logic is as follows: The indexed scene props of ID 1000 are pulled around the virtual object of the player in Y seconds (Y is a configuration value of the first skill), and a distribution shape of the scene props after the scene props are pulled around the virtual object of the player is according to a formation at an accumulation stage.
b) Accumulation stage.
b1) Enter conventional accumulation logic after the foregoing scene prop absorption logic is executed.
b2) Under conventional accumulation logic, the virtual object of the player summons and arranges X (which is a configuration value of the first skill) skill props around the virtual object according to a specific formation. Formation logic includes the following:
b2.1) The formation is an M*N square matrix by default (M and N are configuration values of the first skill), which may support expansion of the formation arrangement by absorbing the scene props inserted into the virtual scene. In an actual application, the formation may be expanded, and various arrangement manners such as a square matrix, a circular matrix, and a semi-circular matrix may be used.
b2.2) Absorbed scene props may be arranged into a formation in a manner of adding columns without adding rows, first to the left and then to the right, and first to the top and then to the bottom.
b2.3) With a 3 (rows)*3 (columns) square matrix as an example, the absorbed first 5 scene props are sequentially merged into the upper left, the middle left, the lower left, the upper right, and the middle right. The scene props are arranged in this manner.
c) Transmission stage.
c1) After the foregoing conventional accumulation logic is executed, all props (including the skill props summoned by the first skill and the scene props absorbed in the virtual scene) are transmitted forward according to a predetermined flight track.
c2) Configuration items of parameters of the transmitted props may be as follows: c2.1) track (a straight line, a line segment, a Bezier curve, or the like); c2.2) locking logic (transmitting along the front, along a point where a target is located at the time of transmission, or the like); c2.3) flight speed; c2.4) flight time (the props disappear when a flight duration upper limit is reached); and c2.5) damage (this configuration item is damage caused by a single prop, and total damage is calculated according to an accumulated quantity of hits by the props).
d) Hitting stage. When the props fly, if the props collide with any target, the following determining is performed:
d1) When a collision unit is a antagonist character target (there is a separate ID classification in a character), corresponding damage is caused to the target, and the props continue to fly according to an original track without disappearing until the flight duration reaches an upper limit; and
d2) If a collision unit is a scene target (there is a separate ID classification in a scene), a classification of the scene target is determined:
d2.1) If the scene target is a virtual scene area of a first type (for example, a mud ground, with a scene object ID 2001), insert the props into the scene target. The props continue to exist after the props are inserted into the scene target until existence duration reaches a configured flight duration upper limit. In addition, the successfully inserted props may be absorbed by the first skill released by the virtual object in the accumulation stage.
d2.2) The virtual scene area of the first type (for example, the mud ground) is converted into a virtual scene area of a second type (a marshland, with a scene object ID 2002), and the virtual scene area of the second type may cause continuous damage by X points of blood per second to an antagonist character target stepping into the virtual scene area until the props disappear for restoration.
c): Disappearance stage. No matter whether props hit or collide in the virtual scene, the props disappear when the configured flight duration upper limit is reached, and the first skill ends.

By application of the above-mentioned aspect described herein, by the first skill, in addition to enabling the first skill to affect the virtual scene, the virtual scene may also affect the first skill in turn, thereby producing a richer game interaction strategy, and providing interaction experience of a more three-dimensional virtual scene. For example, an antagonist virtual object (for example, a monster virtual object) may be guided to release the first skill to change the scene, and the player then go to the vicinity of the scene to strengthen the skill of the player through a scene prop in the scene to attack the opponent, thereby improving fun in the strategy.

An illustrative structure of the apparatus 555 for interaction in a virtual scene according to the aspect described herein implemented as a software module continues to be described below. In some aspects, as shown in FIG. 2, the software module in the apparatus 555 for interaction in a virtual scene stored in a memory 550 may include: a display module 5551, configured to display, in the virtual scene, a first virtual object, a second virtual object, a target scene area, and a scene prop located in the target scene area, the first virtual object having a first skill; and a control module 5552, configured to control, in response to a first trigger operation for the first skill, the scene prop to be separated from the target scene area, and control the separated scene prop to interact with the second virtual object in cooperation with the first virtual object.

In some aspects, the display module 5551 is further configured to generate the scene prop in the target scene area in response to a second trigger operation for the first skill.

In some aspects, the control module 5552 is further configured to control the separated scene prop to be transmitted toward the second virtual object; and reduce an attribute value of an object attribute of the second virtual object when the separated scene prop hits the second virtual object.

In some aspects, the control module 5552 is further configured to control the separated scene prop to be arranged around the first virtual object according to a formation of a target shape; and control, when the first virtual object is attacked by the second virtual object, the separated scene prop to eliminate a negative impact of the attack on the first virtual object.

In some aspects, the control module 5552 is further configured to determine, when a plurality of scene props are provided, a to-be-separated scene prop located in a sensing area of the first virtual object, the plurality of scene props including the to-be-separated scene prop; and control the to-be-separated scene prop to be separated from the target scene area.

In some aspects, the control module 5552 is further configured to determine, when a plurality of scene props are provided, a to-be-separated scene prop transmitted by a target virtual object by releasing the first skill, where the plurality of scene props include the to-be-separated scene prop, and a target relationship exists between the target virtual object and the first virtual object; and control the to-be-separated scene prop to be separated from the target scene area.

In some aspects, the display module 5551 is further configured to display a skill prop generated by the first virtual object by releasing the first skill; and the control module 5552 is further configured to display a process of merging the separated scene prop and the skill prop; and control, when the merging of the separated scene prop and the skill prop ends, the scene prop and the skill prop to be transmitted.

In some aspects, the display module 5551 is further configured to display, when a plurality of skill props are provided, a plurality of skill props that are generated by the first virtual object by releasing the first skill and that are arranged according to a formation of a target shape; and the control module 5552 is further configured to display, according to a formation adding rule, a process of adding the scene prop to the plurality of skill props arranged according to the formation of the target shape.

In some aspects, the display module 5551 is further configured to display target merging duration during which the separated scene prop and the skill prop are merged; and the control module 5552 is further configured to determine, when the target merging duration reaches a merging duration threshold, that the merging of the separated scene prop and the skill prop ends.

In some aspects, the control module 5552 is further configured to obtain a prop movement parameter for the first skill; and control the scene prop and the skill prop that are transmitted to move in the virtual scene according to the prop movement parameter.

In some aspects, the control module 5552 is further configured to determine a collision target of a transmitted target virtual prop in the virtual scene, the target virtual prop including the scene prop and the skill prop; and control the target virtual prop to stay in a virtual scene area of a first type when the collision target is the virtual scene area of the first type, where the target virtual prop staying in the virtual scene area of the first type is configured to control the target virtual prop to be separated from the virtual scene area when a first trigger operation for the first skill is received.

In some aspects, the control module 5552 is further configured to control the virtual scene area of the first type to be converted into a virtual scene area of a second type, where the virtual scene area of the second type is configured to adjust an attribute value of an object attribute of a target virtual object in the virtual scene area of the second type.

In some aspects, the control module 5552 is further configured to control the target virtual prop to disappear from the virtual scene, and control the virtual scene area of the second type to be converted into the virtual scene area of the first type, when duration during which the target virtual prop stays in the virtual scene area reaches a duration threshold, or control the virtual scene area of the second type to be converted into the virtual scene area of the first type after the target virtual prop is separated from the virtual scene area.

In some aspects, the control module 5552 is further configured to determine a collision target of a transmitted target virtual prop in the virtual scene, the target virtual prop including the scene prop and the skill prop; and control the target virtual prop to disappear from the virtual scene when the collision target is a virtual scene area of a third type.

In some aspects, the control module 5552 is further configured to determine a collision target of a transmitted target virtual prop in the virtual scene, the target virtual prop including the scene prop and the skill prop; and adjust an attribute value of an object attribute of the target virtual object when the collision target is the target virtual object.

In some aspects, the control module 5552 is further configured to control the target virtual prop to penetrate the target virtual object, and control the target virtual prop to continue to move; and execute, when the moving target virtual prop collides with a scene target of the virtual scene again, processing logic matching the scene target on the scene target.

In some aspects, the target virtual prop includes a plurality of virtual subprops, and the control module 5552 is further configured to obtain an adjusted value of one virtual subprop for the attribute value and a target quantity of the virtual subprops; and adjust the attribute value of the object attribute of the target virtual object based on the target quantity and the adjusted value.

In some aspects, the display module 5551 is further configured to display skill release prompt information of the scene prop, where the skill release prompt information is configured for prompting that a scene prop separable from the target scene area exists in the virtual scene.

In some aspects, a plurality of scene props are provided; and the control module 5552 is further configured to receive a pressing operation on a skill control for the first skill; adjust a quantity of to-be-separated scene props among the plurality of scene props during execution of the pressing operation; and receive a first trigger operation for the first skill, and determine an adjusted target quantity of the to-be-separated scene props when the pressing operation is released, in response to that the pressing operation is released, the target quantity being less than or equal to the quantity of the scene props; and the control module 5552 is further configured to control the target quantity of scene props to be separated from the target scene area.

In application of the above-mentioned aspects described herein, the first virtual object, the second virtual object, the target scene area, and the scene prop located in the target scene area are displayed in the virtual scene, and when the first trigger operation for the first skill is received, the scene prop is controlled to be separated from the target scene area, so that the separated scene prop is controlled to interact with the second virtual object in cooperation with the first virtual object. Herein, the scene prop is provided in the target scene area of the virtual scene. If the first virtual object triggers the first skill during interaction, the scene prop of the target scene area can be invoked to interact with the second virtual object in cooperation with the first virtual object. In this way, the target scene area of the virtual scene provides the scene prop for the first skill to invoke, and application manners of a virtual skill in the virtual scene can be enriched, thereby improving efficiency of interaction control of the virtual scene, and improving utilization of hardware processing resources. 2) The diversity of skills can be enriched, and an application strategy of the skills can be increased, thereby improving interaction experience of the virtual scene.

An aspect described herein further provides a computer program product, including computer-executable instructions or a computer program. The computer-executable instructions or the computer program is stored in a computer-readable storage medium. A processor of an electronic device reads the computer-executable instructions or the computer program from the computer-readable storage medium, and the processor executes the computer-executable instructions or the computer program, to cause the electronic device to perform the method for interaction in a virtual scene according to the aspect described herein.

An aspect described herein further provides a computer-readable storage medium, having computer-executable instructions or a computer program stored therein, the computer-executable instructions or the computer program, when executed by a processor, causing the processor to perform the method for interaction in a virtual scene according to the aspect described herein.

In some aspects, the computer-readable storage medium may be a memory such as a random access memory (RAM), a read-only memory (ROM), a flash memory, a magnetic surface memory, a compact disc, or a compact disc read-only memory (CD-ROM), or may be various devices including one or any combination of the above-mentioned memories.

In some aspects, the computer-executable instructions may be written in a form of a program, software, a software module, a script, or code in any form of programming language (including compiled or interpretive language, or declarative or procedural language), and the computer-executable instructions may be deployed in any form, including being deployed as an independent program or being deployed as a module, component, subroutine, or another unit suitable for use in a computing environment.

In an example, the computer-executable instruction may but might not necessarily correspond to a file in a file system, and may be stored in a part of the file for storing other programs or data, for example, stored in one or more scripts in a hypertext markup language (HTML) document, stored in a single file specially for the discussed program, or stored in a plurality of collaborative files (for example, files storing one or more modules, a subroutine, or a code part).

In an example, the computer-executable instructions may be deployed to be executed on one electronic device, or on a plurality of electronic devices located at one location, or on a plurality of electronic devices distributed at a plurality of locations and connected by a communication network.

The foregoing descriptions are only aspects described herein and are not intended to limit the protection scope described herein. Any modification, equivalent replacement, improvement, and the like made within the spirit and scope described herein fall within the protection scope described herein.

What is claimed is:

1. A computer implemented method, comprising:
displaying, in a virtual scene, a first virtual character, a second virtual character, a target scene area, and a scene prop located in the target scene area, the first virtual character having a first skill;
displaying, in response to a first trigger operation corresponding to the first skill, the scene prop as separated from the target scene area; and
controlling the separated scene prop to interact between the second virtual character and the first virtual character.

2. The method according to claim 1, wherein the method further comprises:
generating the scene prop in the target scene area in response to a second trigger operation for the first skill.

3. The method according to claim 1, wherein the displaying the scene prop to be separated from the target scene area comprises:
determining, when a plurality of scene props are provided, a to-be-separated scene prop located in a sensing area of the first virtual character, the plurality of scene props comprising the to-be-separated scene prop; and
controlling the to-be-separated scene prop to be separated from the target scene area.

4. The method according to either claim 1, wherein the displaying the scene prop to be separated from the target scene area comprises:
determining, when a plurality of scene props are provided, a to-be-separated scene prop transmitted by a target virtual character by releasing the first skill,
wherein the plurality of scene props comprise the to-be-separated scene prop, and a target relationship exists between the target virtual character and the first virtual character; and
controlling the to-be-separated scene prop to be separated from the target scene area.

5. The method according to claim 1, wherein the controlling the separated scene prop to interact with the second virtual character comprises:
controlling the separated scene prop to be transmitted toward the second virtual character; and
reducing an attribute value of an object attribute of the second virtual character when the separated scene prop hits the second virtual character.

6. The method according to claim 1, wherein the controlling the separated scene prop to interact with the second virtual character comprises:
controlling the separated scene prop to be arranged around the first virtual character according to a formation of a target shape; and
controlling, when the first virtual character is attacked by the second virtual character, the separated scene prop to eliminate a negative impact of the attack on the first virtual character.

7. The method according to claim 1, further comprising:
displaying a skill prop generated by the first virtual character by releasing the first skill; and
the displaying the separated scene prop to interact with the second virtual character comprises:
displaying a process of merging the separated scene prop and the skill prop; and
controlling, when the merging of the separated scene prop and the skill prop ends, transmission of the merged scene prop and skill prop.

8. The method according to claim 7, wherein the displaying the skill prop comprises:
displaying, when a plurality of skill props are provided, a plurality of skill props that are generated by the first virtual character by releasing the first skill and that are arranged according to a formation of a target shape; and
the displaying the process of merging the separated scene prop and the skill prop comprises:
displaying, according to a formation adding rule, a process of adding the scene prop to the plurality of skill props arranged according to the formation of the target shape.

9. The method according to claim 7, further comprising:
obtaining a prop movement parameter for the first skill; and
controlling the scene prop and the skill prop that are transmitted to move in the virtual scene according to the prop movement parameter.

10. The method according to claim 7, further comprising:
determining a collision target of a transmitted target virtual prop in the virtual scene, the target virtual prop comprising the scene prop and the skill prop; and
controlling the target virtual prop to stay in a virtual scene area of a first type when the collision target is the virtual scene area of the first type,
wherein the target virtual prop staying in the virtual scene area of the first type is configured to control the target virtual prop to be separated from the virtual scene area when a first trigger operation for the first skill is received.

11. The method according to claim 10, wherein after the controlling the target virtual prop to stay in the virtual scene area of a first type, the method further comprises:
controlling the virtual scene area of the first type to be converted into a virtual scene area of a second type,
wherein the virtual scene area of the second type is configured to adjust an attribute value of an object attribute of a target virtual character in the virtual scene area of the second type.

12. The method according to claim 11, wherein the method further comprises:
controlling the target virtual prop to disappear from the virtual scene, and controlling the virtual scene area of the second type to be converted into the virtual scene area of the first type, when a duration during which the target virtual prop stays in the virtual scene area reaches a duration threshold, or
controlling the virtual scene area of the second type to be converted into the virtual scene area of the first type after the target virtual prop is separated from the virtual scene area.

13. The method according to claim 7, wherein the method further comprises:
determining a collision target of a transmitted target virtual prop in the virtual scene, the target virtual prop comprising the scene prop and the skill prop; and
controlling the target virtual prop to disappear from the virtual scene when the collision target is a virtual scene area of a third type.

14. The method according to claim 7, wherein the method further comprises:
determining a collision target of a transmitted target virtual prop in the virtual scene, the target virtual prop comprising the scene prop and the skill prop; and
adjusting an attribute value of an object attribute of the target virtual character when the collision target is the target virtual character.

15. The method according to claim 14, wherein after the adjusting the attribute value, the method further comprises:
controlling the target virtual prop to penetrate the target virtual character, and controlling the target virtual prop to continue to move; and
executing, when the moving target virtual prop collides with a scene target of the virtual scene again, processing logic matching the scene target on the scene target.

16. The method according to claim 14, wherein the target virtual prop comprises a plurality of virtual subprops, and the adjusting the attribute value of the object attribute of the target virtual object comprises:
obtaining an adjusted value of one virtual subprop for the attribute value and a target quantity of the virtual subprops; and
adjusting the attribute value of the object attribute of the target virtual character based on the target quantity and the adjusted value.

17. The method according to claim 1, further comprising:
displaying skill release prompt information of the scene prop,
wherein the skill release prompt information is configured for prompting that a scene prop separable from the target scene area exists in the virtual scene.

18. The method according to claim 1, wherein a plurality of scene props are provided; and the method further comprises:
receiving a pressing operation on a skill control for the first skill;
adjusting a quantity of to-be-separated scene props among the plurality of scene props during execution of the pressing operation; and
receiving a first trigger operation for the first skill, and determining an adjusted target quantity of the to-be-separated scene props when the pressing operation is released, in response to that the pressing operation is released, the target quantity being less than or equal to the quantity of the scene props; and
the controlling the scene prop to be separated from the target scene area comprises:
controlling the target quantity of scene props to be separated from the target scene area.

19. A non-transitory computer readable medium comprising computer readable instructions which, when executed by a processor, configure a data processing system to perform:
displaying, in a virtual scene, a first virtual character, a second virtual character, a target scene area, and a scene prop located in the target scene area, the first virtual character having a first skill;
displaying, in response to a first trigger operation corresponding to the first skill, the scene prop as separated from the target scene area; and
controlling the separated scene prop to interact between the second virtual character and the first virtual character.

20. A system, comprising:
a processor; and
memory storing computer readable instructions which, when executed by the processor, configure the system to perform:
displaying, in a virtual scene, a first virtual character, a second virtual character, a target scene area, and a scene prop located in the target scene area, the first virtual character having a first skill;
displaying, in response to a first trigger operation corresponding to the first skill, the scene prop as separated from the target scene area; and
controlling the separated scene prop to interact between the second virtual character and the first virtual character.
